(19) United States
(12) Patent Application Publication
(10) Pub. No.: US 2007/0085997 A1
(43) Pub. Date: Apr. 19, 2007

(54) Flow cytometry

(76) Inventor: Richard A. Thomas, Miami, FL (US)

Correspondence Address: MCDERMOTT, WILL & EMERY, 4370 LA JOLLA VILLAGE DRIVE, SUITE 700, SAN DIEGO, CA, 92122, US

(21) Appl. No.: 11/544,239

(22) Filed: Oct. 6, 2006

Related U.S. Application Data
(60) Provisional application No. 60/724,618, filed on Oct. 7, 2005.

(51) Int. Cl. G01N 21/00

(52) U.S. Cl. 356/72

(57) ABSTRACT

The invention provides a flow transducer such as a flow cytometer for making simultaneous electronic and optical measurements on a particle flowing through a sensing zone.

This application claims the benefit of priority of U.S. Provisional application Ser. No. 60/724,618, filed Oct. 7, 2005, the entire contents of which are incorporated herein by reference.

### BACKGROUND OF THE INVENTION

The present invention relates generally to analytical instruments and more specifically to flow cytometry.

Flow cytometry is a technique for counting, examining and sorting microscopic particles suspended in a stream of fluid. It allows simultaneous multiparametric analysis of the physical and/or chemical characteristics of single cells flowing through an optical/electronic detection apparatus. A beam of light, usually laser light, of a single frequency (color) is directed onto a hydrodynamically focused stream of fluid. A number of detectors are aimed at the point where the stream passes through the light beam; one in line with the light beam (Forward Scatter or FSC) and several perpendicular to it (Side Scatter (SSC) and one or more fluorescent detectors. Each suspended particle passing through the beam scatters the light in some way, and fluorescent chemicals in the particle may be excited into emitting light at a lower frequency than the light source. This combination of scattered and fluorescent light is picked up by the detectors, and by analyzing fluctuations in brightness at each detector (one for each fluorescent emission peak), it is possible to deduce various facts about the physical and chemical structure of each individual particle. FSC correlates with the cell size and SSC depends on the inner complexity of the particle, such as shape of the nucleus, the amount and type of cytoplasmic granules or the membrane roughness. There are now some flow cytometers on the market that have eliminated the need for fluorescence and use only light scatter for measurement.

Modern flow cytometers can analyze several thousand particles every second in “real time” and can actively separate out and isolate particles having specified properties. A flow cytometer is similar to a microscope, except it doesn't produce an image of the cell but offers high-throughput automated quantification of the set parameters for a high number of single cells during each analysis session. Solid tissues have to be prepared to a single-cell suspension for analysis.

Modem instruments have multiple lasers and fluorescence detectors, for example up to 4 lasers and 18 fluorescence detectors, allowing multiple antibody labeling to be used to more precisely specify a target population by their phenotype. Certain instruments can image the cells, allowing the analysis of fluorescent signal location within cells. Flow cytometers can also be configured as sorting instruments. As cells/particles pass through they can be selectively charged and on their exit can be deflected into separate paths of flow. It is therefore possible to separate more than 5 defined populations of cells from an original mix with a high degree of accuracy and speed (up to ˜90,000 cells per second in theory).

The data coming from flow-cytometers can be plotted in 1 dimension to produce histograms or seen in 2 dimensions as dot plots or in 3 dimensions with newer software. The regions on these plots can be sequentially separated by a series of subset extractions which are termed gates. Specific gating protocols exist for diagnostic and clinical purposes especially in relation to haematology. The plots are often made on logarithmic scales. Because different fluorescent dye's emission spectra overlap, signals at the detectors have to be compensated electronically as well as computationally.

Flow cytometry has applications in a number of fields, including molecular biology, pathology, immunology, plant biology and marine biology. Due to its numerous uses, it would be advantageous to develop improved flow cytometers providing enhanced detection, measurement and analysis of the sample cells. The present invention satisfies this need, and provides related advantages as well.

### SUMMARY OF INVENTION

The invention provides a flow transducer such as a flow cytometer for making simultaneous electronic and optical measurements on a particle flowing through a sensing zone.

### BRIEF DESCRIPTION OF THE DRAWINGS

The patent or application file contains at least one drawing executed in color. Copies of this patent or patent application publication with color drawings will be provided by the Office upon request and payment of the necessary fee

FIG. 1A shows a block diagram of an exemplary flow cytometer.

FIG. 1B shows a diagram of a representative transducer of the invention.

FIG. 1C shows an enlarged diagram of the aperture shown in FIG. 1B.

FIGS. 2A-2C show three graphs of unstained Jurkat cells. FIG. 2A depicts the Electronic Cell Volume distributions of the cells. FIG. 2C shows the Side Scatter (light) distribution of the same cells. FIG. 2B shows a cell-by-cell representation of the Electronic Cell Volume and Side Scatter data for each individual cell in the population.

FIGS. 3A and 3B show cell viability of Jurkat cells stained with propidium iodide for cell viability analysis and back gated into the Electronic Cell Volume (ECV) versus Side Scatter (SS). It is clear that the dead cells (green) are clearly differentiated from the viable cells (red) in the ECV vs. SS plot.

FIG. 4 shows a typical Side Scatter vs DNA plot, where the cells have been stained with propidium iodide (PI) after permeabilization.

FIG. 5 shows a plot of the same cells as in FIG. 4 using Electronic Cell Volume vs DNA.

FIG. 6 shows a plot of the Electronic Volume distribution of the same cells as in FIG. 4.

FIG. 7 shows a plot of the Side Scatter distribution of the same cells as in FIG. 4.

FIG. 8 shows yeast budding detection by combining electronic cell volume with light scatter. Depicted is a plot of Electronic Cell Volume vs Side Scatter on the same cells as in FIG. 4.

### DETAILED DESCRIPTION OF THE INVENTION

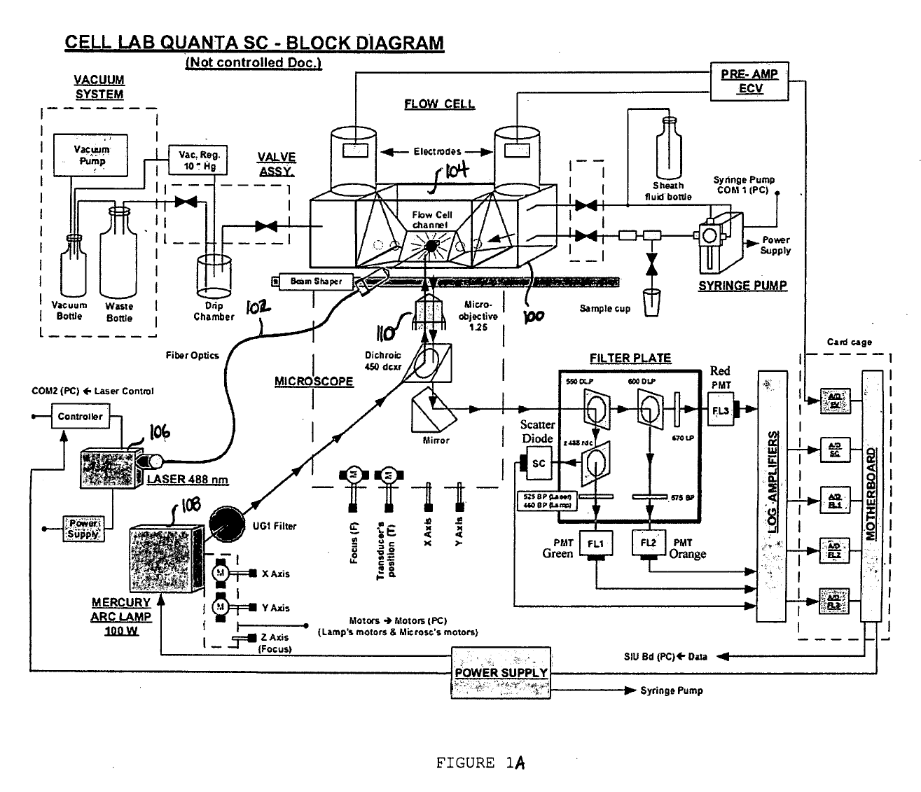

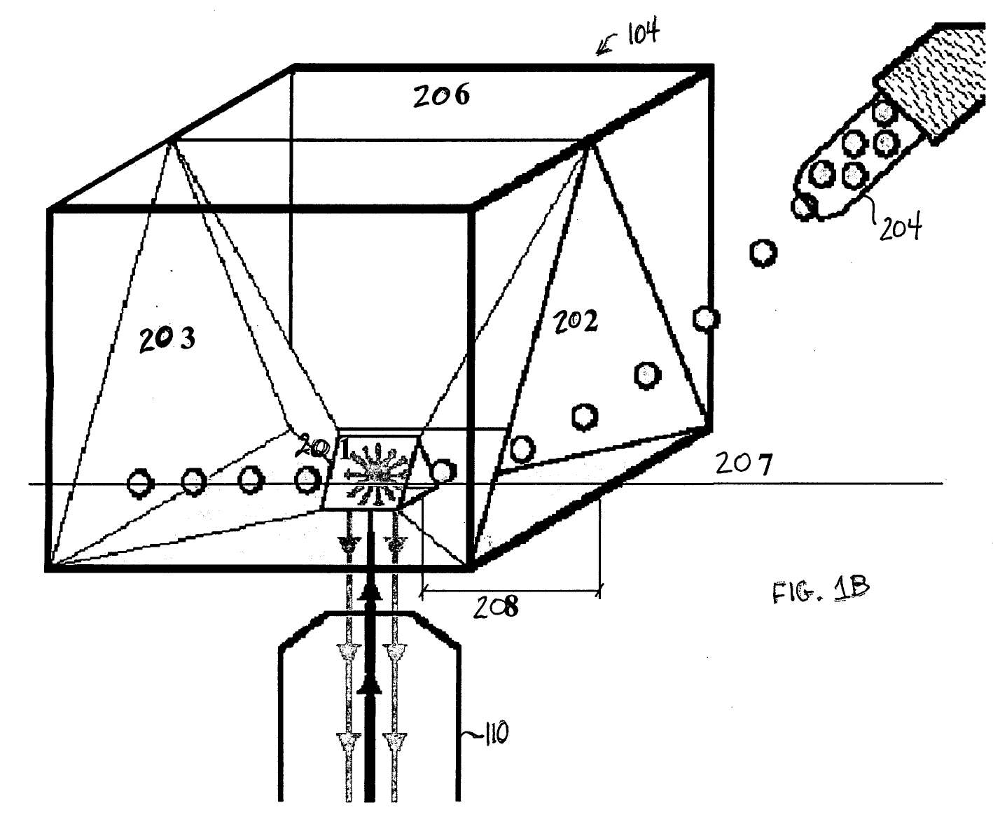

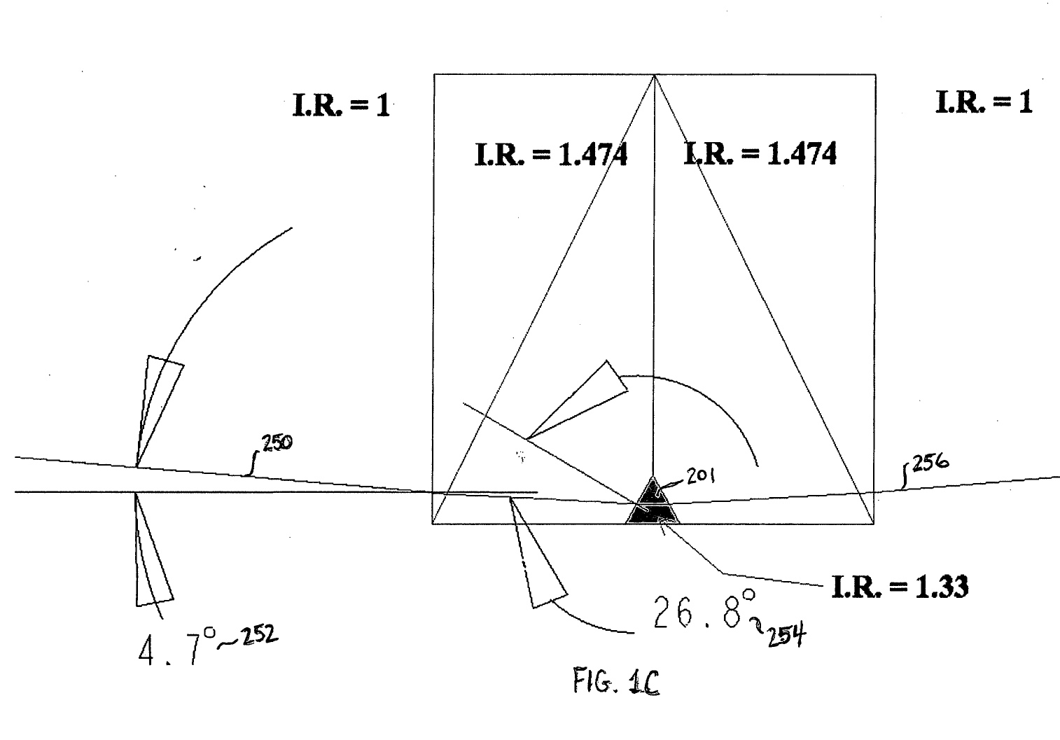

The present invention relates to flow cytometers and methods of using same. A flow cytometer of the invention, as exemplified in FIG. 1, includes a laser. Unlike previous flow cytometers, which may have simply used an arc lamp or some other ultraviolet light (UV) source alone in epi illumination mode, or a laser in orthogonal mode, the present system includes the laser as a light source in orthogonal mode in addition to the UV source in epi illumination mode. In particular, the laser is oriented perpendicular to the direction of flow of sample through the flow channel, and the scattered light is collected through the objective that forms the epi illumination focus source. Within this perpendicular orientation, energy from the laser strikes the sample and light is collected at 90 degrees +/−60 degrees. Such an arrangement advantageously provides side scatter off the cells as well as forward scatter, which is detected in line with the laser excitation. This enhances the detection, measurement, and analysis of the sample cells.

The laser may be of any of a wide variety of wavelengths and powers without departing from the scope of the present invention. In one particular embodiment, a laser contemplated has a wavelength of 488 nm and a power range of approximately 20 mw. Other exemplary wavelengths of laser useful in an invention apparatus are generally in the range of the excitation maxima for a fluorophore used to analyze a sample in the apparatus. Exemplary wavelengths of useful fluorophores are shown in Tables 1 and 2. These and other suitable wavelengths of laser useful in an apparatus can be used as suited for a particular use of the apparatus.

An apparatus of the invention is useful to measure a variety of parameters, including but not limited to, volume and morphological complexity of cells; cell pigments such as chlorophyll or phycoerythrin; DNA, including cell cycle analysis, cell kinetics, cell proliferation, and the like; RNA; chromosome analysis and sorting such as library construction, or chromosome painting; proteins; cell surface antigens (CD markers); intracellular antigens, including various cytokines, secondary mediators, and the like; nuclear antigens; enzymatic activity; pH, intracellular ionized calcium, magnesium, membrane potential; membrane fluidity; apoptosis including quantification, measurement of DNA degradation, mitochondrial membrane potential, permeability changes, caspase activity, and the like; cell viability; monitoring electropermeabilization of cells; oxidative burst; characterizing multi-drug resistance (MDR) in cancer cells; glutathione; various combinations such as DNA/surface antigens, and the like.

An apparatus of the invention such as a flow cytometer has 5 main components: (1) a flow cell—liquid stream (sheath fluid) carries and aligns the particles so that they pass in a single file through the light beam for sensing; (2) light source—commonly used are lamps (mercury, xenon); high power water-cooled lasers (argon, krypton, dye laser); low power air-cooled lasers (argon (488 nm), red-HeNe (633 nm), green-HeNe, HeCd (UV)); diode lasers (blue, green, red, violet); (3) detection and Analogue to Digital Conversion (ADC) system—generating FSC and SSC as well as fluorescence signals; (4) amplification system—linear or logarithmic amplification and/or conditioning of signals; (5) computer for analysis of the signals.

An apparatus of the invention has applications in a number of fields, including but not limited to molecular biology, pathology, immunology, plant biology and marine biology. In the field of molecular biology it is especially useful when used with fluorescence tagged antibodies. These specific antibodies bind to antigens on the target cells and help to give information on specific characteristics of the cells being studied in the cytometer. It has broad application in medicine, especially in transplantation, heamatology, tumor immunology and chemotherapy, and genetics. In marine biology, the autofluorescent properties of photosynthetic plankton can be exploited by flow cytometry in order to characterise abundance and community structure. In protein engineering, flow cytometry can be used in conjunction with yeast display and bacterial display to identify cell surface-displayed protein variants with desired properties.

In one embodiment, the invention provides a flow transducer comprising means defining an aperture having an axis, the aperture having at least one flat side, means defining an inlet chamber and an outlet chamber immediately adjacent the aperture along its axis, at least one of the inlet and outlet chamber having walls disposed at an angle of at least 5 degrees relative to a plane of the aperture, the at least one of the inlet and outlet chambers at a distance from the aperture of twice the width of the aperture in a plane through its axis having a cross-section area greater than 1.10 but less than 10 times the cross-sectional area of the aperture.

FIG. 1A depicts a block diagram of an exemplary flow cytometer for analyzing various particles in accordance with the principles of the present invention. The operation of many of the elements of FIG. 1A are well known in this field and are explained in detail in the incorporated patents. Thus, the detailed description of some of the elements of FIG. 1A provided herein focuses more on those elements of the present invention that differ from well known flow cytometers.

A flow cell 100 is also referred to sometimes as a transducer in that it takes a physical phenomenon and converts it into an electrical signal. The physical phenomenon relates to the passage through the flow cell 100 of a stream of particles suspended in a saline, or similar, solution. As the stream passes through a narrow region of the flow cell, its resistivity changes such that it can be easily and accurately detected. Aspects of the present invention operate to improve the manner in which the stream of particles flows so that detecting changes is both more accurate and simpler.

In addition to detecting electrical-related changes associated with the particle stream, light-related aspects of the particles are detected as well. For example, the system of FIG. 1A includes a laser 106 and a mercury lamp 108 that illuminate at least a portion of the particle stream. The light which scatters as a result of this illumination or the fluorescence of particles that results from this illumination are detected as well. As shown in FIG. 1A, the laser may reach the flow cell 100 via a fiber 102 or some other type of optical waveguide. Light from the arc lamp 108 may reach the flow cell 100 after passing through an objective lens 110 which also is used to collect light that scatters off or fluoresces from the particles in the flow cell 100.

In operation, the arc lamp 108 is used in a typical epi-illumination mode while the laser 106 impinges the particle stream in a direction generally orthogonal to that of the arc lamp 108. Thus, in addition to sensing electrical differences occurring in the particle stream, two different light-related phenomena may be concurrently detected as well. The result light from the epi-illumination and the resulting light from the orthogonal laser illumination may both be detected at approximately the same time.

FIG. 1B depicts a more detailed view of a portion of the flow cell 104. The portion in this figure includes an inlet chamber 202, and outlet chamber 203, and an aperture 201 located in-between. An injector 204 provides a stream of particles that enter the inlet chamber 202, pass through the aperture 201, and exit via the outlet chamber 203.

The aperture 201 is also referred to as the sensing zone and may be a small triangular cylinder in the middle of the transducer, as shown in FIG. 1B. The shape of the chambers 202, 203 and the aperture 201 are exemplary in nature and are not necessarily triangular shaped as explicitly depicted. Other polygonal shapes or even cylindrical shapes are contemplated within the scope of the present invention.

The inlet chamber 202 is the triangular cone leading up to the sensing zone or aperture 201. The outlet chamber 203 is the triangular cone leading away from the sensing zone or aperture 201. The distance 208 from the aperture inlet to the inlet chamber is the distance from the triangular plane forming the front of the aperture 201 to a parallel plane passing through the inlet 202 chamber along the aperture axis 207. A similar distance may be defined for the outlet chamber 203 as well. One important aspect of these elements is the ratio of the two triangular cross-sectional areas—that of the chamber (inlet or outlet) and the aperture. Properly selecting these shapes and areas will allow the flow of particles in the chamber to remain constant and smooth.

The microobjective 110 and its impinging and return light paths are depicted in FIG. 1B as well. However, the laser light, which is orthogonal to the other light path, is more easily depicted with reference to both FIG. 1B and FIG. 1C.

The polygon that the laser light enters is the rear polygon of FIG. 1B. It enters near the bottom of the polygon at about a 4.5 degree angle 250 (of FIG. 1C) such that it strikes the aperture 201 approximately on its face at a point that forms angle 254 with respect to the aperture axis. The difference between the index of refraction (i.r.) of the air to the i.r of the glass polygon bends the light upward. The intersection with the wall of the triangular cone aperture 201 further bends the light, and the final result is a beam which is approximately parallel to the bottom surface of the triangular cylinder aperture 201. It then passes through the opposite wall of the triangular cylinder aperture 201 and exits 256 the front surface of the clear polygon.

The scattered light is picked up by the microobjective which has an numerical aperture of about 1.4 and can accept about 120 degrees of light scattering from the particle. The specific angles and polygons shown if FIGS. 1B and 1C are exemplary in nature and may vary without departing from the intended scope of the present invention. For example, depending on the size and shape of the polygons which form the aperture 201, the attack angle of the laser may vary from around −2 degrees to about +9 degrees. The approximately +4.7 degrees advantageously produces a beam which is approximately parallel to the floor, or base, of the aperture 201. As a result, the beam passes through the aperture 201 at a point that optimally intersects the particle stream where it is most stable (i.e., such a point is the intersection of the equilateral bisectors of the equilateral triangle's cross section). In operation, other specific arrangements may be selected and utilized that allow the laser light to pass totally through the aperture without intersecting any of the walls of the other polygons that form the aperture. The actual attack angle of the incident illumination is dependent on the index of refraction of the material from which the polygons are made. Thus, other angles of attack are contemplated, dependent on the specific materials used, that will also result in the parallelism described above.

In another embodiment, the invention provides a transducer such as a flow cell for a flow cytometer, wherein the transducer is formed of a plurality of solid polygons joined such that adjacent flat surfaces of the polygons define walls of the aperture for the flow transducer, and others of the surfaces of the polygons define the at least one of the inlet and outlet chambers. In such a transducer, others of the surfaces can be interior surfaces of the polygons that define the at least one of the inlet and outlet chambers, and others of the exterior surfaces of the polygons form optical elements that are flat, spherical, aspherical or have a graded index to focus the exciting light, the emitted light, or the scattered light. Thus, the objective such as a microobjective can be part of the wall of the flow transducer or flow cell.

In yet another embodiment, the invention provides a flow cytometer for making simultaneous electronic and optical measurements on a particle flowing through a sensing zone thereof, comprising a transducer formed of a plurality of solid polygons joined such that adjacent flat surfaces of the polygons define a polygonal aperture at the sensing zone and other surfaces of the polygons define inlet and outlet chambers to the aperture, at least one of the inlet and outlet chambers having a predefined geometric relation to the aperture, the inlet and outlet chambers defining an arch shaped fluid passageway with the aperture at the arch vertex, means for establishing a flow of electrolyte through the aperture, the inlet and outlet chambers being configured to establish laminar flow of the electrolyte through the aperture, injector means for injecting samples of particles into the laminar flow of electrolyte, one or more electrodes coupled to the inlet chamber and one or more electrodes coupled to the outlet chamber, means for establishing a current flow through the aperture between the electrodes, monitoring means for monitoring the electrical current flow through the aperture, at least one of the solid polygons defining the aperture being an element in an optical measurement system, the system including means for introducing exciting light through the at least one solid polygon into the aperture, and means for collecting light from a sample particle in the aperture through the same polygon or another polygon.

In still another embodiment, the invention provides a flow transducer comprising means defining an aperture having an axis, the aperture having at least one flat side, means defining an inlet chamber and an outlet chamber immediately adjacent the aperture along its axis, at least one of the inlet and outlet chamber having some part of the wall curved walls, where the chambers at a distance from the aperture of twice the width of the aperture in a plane through its axis having a cross-section area greater than 1.5 times the cross-sectional area of the aperture, and the aperture length greater than 0.1 times the width of the aperture, and less than 4 times the width of the aperture, where the width is the largest dimensions measured perpendicular to the axis.

In an additional embodiment, the invention provides a transducer such as a flow cell for a flow cytometer, wherein the transducer is formed of a plurality of solid polygons joined such that adjacent flat surfaces of the polygons define walls of the aperture for the flow cytometer, and others of the surfaces of the polygons define the at least one of the inlet and outlet chambers. In such a transducer, others of the surfaces can be interior surfaces of the polygons that define the at least one of the inlet and outlet chambers, and others of the exterior surfaces of the polygons form optical elements that are flat, spherical, aspherical or have a graded index to focus the exciting light, the emitted light, or the scattered light.

The invention also provides in another embodiment a flow cytometer for making simultaneous electronic and optical measurements on a particle flowing through a sensing zone thereof, comprising a transducer such as a flow cell formed of a plurality of solid polygons joined such that adjacent flat surfaces of the polygons define a polygonal aperture at the sensing zone and other surfaces of the polygons define inlet and outlet chambers to the aperture, at least one of the inlet and outlet chambers having a predefined geometric relation to the aperture, the inlet and outlet chambers defining an arch shaped fluid passageway with the aperture at the arch vertex, means for establishing a flow of electrolyte through the aperture, the inlet and outlet chambers being configured to establish laminar flow of the electrolyte through the aperture, injector means for injecting samples of particles into the laminar flow of electrolyte, one or more electrodes coupled to the inlet chamber and one or more electrodes coupled to the outlet chamber, means for establishing a current flow through the aperture between the electrodes, monitoring means for monitoring the electrical current flow through the aperture, at least one of the solid polygons defining the aperture being an element in an optical measurement system, the system including means for introducing exciting light through the at least one solid polygon into the aperture, and means for collecting light from a sample particle in the aperture.

The invention additionally provides a flow cytometer including a laser configured to impinge on a cell at an angle to produce side scattering.

In one embodiment, the invention provides a flow cytometer comprising an aperture configured to provide a pathway for a stream of particles; a lamp configured to epi-illuminate at least a portion of the pathway; a laser configured to illuminate the pathway in a direction approximately orthogonal to illumination from the lamp; and a detector system configured to detect a result on the stream of particles from both the lamp and the laser. In another embodiment, the detector system includes a single objective lens. In yet another embodiment, the detector system is configured to sense side scatter resulting from the laser. In still another embodiment, the detector system includes a sensing window of approximately 120 degrees. In still another embodiment, the aperture comprises a polygon having an equilateral triangular cross-section shape. In another embodiment, an attack angle of illumination from the laser is approximately +4.5 degrees relative to a base of the aperture. In still another embodiment, illumination from the laser while in the aperture is approximately parallel to a base of the aperture. In yet another embodiment, a fiber is configured to direct illumination from the laser onto the pathway.

Exemplary flow cytometers that can be modified in accordance with the disclosure herein include, but are not limited to, those described in U.S. Pat. Nos. 4,673,288 and 4,818,103, each of which is incorporated herein by reference in their entirety.

Flow cytometry and its uses are well known to those skilled in the art (see, for example, Ormerod, Flow Cytometry 2nd ed., Springer-Verlag, New York (1999), which is incorporated herein by reference. Such uses include, but are not limited to, immunofluorescence labeling of cell surface antigens using monoclonal antibodies. Clinical applications include, but are not limited to, immunophenotypic analysis of leukemias and lumphomas, detection of minimal residual disease, stem cell enumeration, solid organ transplantation, including T cell cross matching and postoperative monitoring, detection of auto-antibodies, HIV infection, feto-matemal hemorrhage, immunodeficiency diseases, paroxysmal nocturnal hemoglobinuria, reticulocyte analysis, cell cycle analysis, cell proliferation, apoptosis, RNA content, protein content, kinetic analysis of intracellular enzymes, membrane permeability, membrane potential, production of intracellular oxidative species, measurement of drug uptake, binding and endocytosis of ligands, intracellular calcium ions, intracellular pH, intracellular glutathione, chromosome analysis and sorting, tracking cells, measuring cell viability, monitoring electropermeabilization, monitoring fusion or clustering of cells, microbead technology, and the like.

Exemplary fluorophores for labeling proteins include, but are not limited to, those listed in Table 1 (taken from Ormerod, supra, 1999).

TABLE 1
Properties of some fluorophores used to label proteins

| | Excitation | Emission |
|---|---|---|
| Fluorophore | maxima (nm) | maximum (nm) |
| Fluorescein | 495 | 520 |
| R-phycoerythrin | 495, 564 | 576 |
| Texas Red | 596 | 620 |
| Phycoerythrin - Texas Red conjugate | 495 | 620 |
| Phycoerythrin - cyanine5 conjugate | 495 | 670 |
| Peridinin chlorophyll-A protein | 490 | 677 |
| Allophycocyanin | 650 | 660 |
| Coumarin | 357 | 460 |

The wavelengths of absorption and emission may depend on the nature of the conjugate used and its environment.

Exemplary fluorphores for labeling nucleic acids include, but are not limited to, those listed in Table 2 (taken from Ormerod, supra, 1999).

TABLE 2
The properties of some fluorophores used to label nucleic acids

| Fluorophore | Excitation maxima (nm) | Emission maximum (nm) |
|---|---|---|
| Propidium iodide | 535, 342 | 617 |
| Ethidium bromide | 518, 320 | 605 |
| TO-PRO-3 | 642 | 661 |
| LDS 751 | 543 | 712 |
| Acridine orange | 503 | 530 (DNA); 640 (RNA) |
| Mithramycin | 445 | 569 |
| Chromomycin A3 | 430 | 580 |
| Hoechst 33342 | 395 | 450 |
| DAPI | 372 | 456 |
| Pyronin Y | 545 | 565 |

The fluorescent properties of most of these dyes change on binding to nucleic acid. The wavelengths given are those of the dye-nucleic acid complex.

The invention also provides a method of using an apparatus of the invention, such as a flow transducer or flow cytometer. In one embodiment, the invention provides a method for identifying viable cells by passing a population of cells through a flow transducer or flow cytometer of the invention and identifying viable cells in the cell population. An exemplary method for identifying or determining cell viability in a population of cells is described in Example II. In another embodiment, the invention provides a method for identifying budding yeast by passing a population of yeast cells through a flow transducer or flow cytometer of the invention and identifying budding yeast cells in the cell population. An exemplary method for identifying or determining budding yeast in a population is described in Example II. Such an assay is particularly useful for analyzing a population of yeast in growth phase.

An apparatus of the invention can be used, for example, to measure cell viability, which can be an important parameter to measure in flow cytometric analyses. It can be used as a quantitative parameter to assess the cytotoxicity of exogenous substrates or drugs, cytotoxic cellular interactions or as a method to eliminate dead cells from immunofluorescence analysis since non-viable cells may show different patterns of non-specific antibody binding compared to intact viable, competent cells. There are several methods that can be used to quantitate viability of cells. These methods typically use non-permeant dyes, for example, propidium iodide (PI) and 7-Amino Actinomycin D (7-AAD) that do not enter cells with intact cell membranes or active cell metabolism. Cells with damaged plasma membranes or with impaired/no cell metabolism are unable to prevent the dye from entering the cell. Once inside the cell, the dyes bind to intracellular structures producing highly fluorescent adducts which identify the cells as non-viable. Other methods can be used to assess viability by detection of active cell metabolism, which can result in the conversion of a non-fluorescent substrate into a highly fluorescent product, for example, fluorescein diacetate (FDA).

Propidium idodide (PI) is a non-permeant dye that can penetrate the membranes of dying/dead cells. It intercalates into the major groove of the DNA and produces a highly fluorescent adduct, so non-viable cells can be identified by positive (red) fluorescence. PI can be excited at 488 nm and its fluorescence detected from 550 up to 670 nm. Despite the broad emission spectrum of PI, it can be used in combination with other 488 nm-excited fluorochromes like fluorescein isothiocyanate (FITC) and phycoerythrin (PE) but proper compensation is to be used to ensure correct identification of PI(+) and PI(−) cells from those stained with the other fluorescent markers.

7-amino actinomycin D (7-AAD) is another non-permeant dye that can be used to identify non-viable cells. The 7-AAD is excited by the 488 nm laser line of an argon laser with fluorescence detected above 650 nm. Although the emission intensity of 7-AAD is lower than that of PI, the longer wavelength emission may make it more useful in combination with other 488 nm-excited fluorochromes such as FITC and PE.

Fluorescein diacetate (FDA) is a non-polar, non-fluorescent fluorescein analogue which can pass through the cell membrane whereupon intracellular esterases cleave off the diacetate group, producing the highly fluorescent product fluorescein. The fluorescein accumulates in cells possessing intact membranes, so the green fluorescence can be used as a marker of cell viability. Cells which do not possess an intact cell membrane or an active metabolism may not accumulate the fluorescent product and therefore do not exhibit green fluorescence. This may be used in combination with PI staining as the non-viable cells will take up the PI and stain RED whereas viable cells will not take up the PI and should only stain green. This 2-color separation of non-viable and viable cells provides for a more accurate quantitation of cell viability than single color analysis.

Light scatter and fluorescence have long been valuable parameters in flow cytometry. Electronic Cell Volume (ECV) has long been a valuable parameter in blood analysis, but has not been used in flow cytometry. Over the last several years Electronic Cell Volume has been used in conjunction with fluorescence in flow cytometry with increasing value in small particle analysis, Nuclear Packing Efficiency, and bacterial analysis (for discussion of ECV and nuclear packing efficiency, see, for example, U.S. Pat. Nos. 4,673,288, 4,818,103 and 6,587,792. Until now, no instrument has combined the Electronic Cell Volume and Side Scatter measurements simultaneously in a single instrument. The data presented herein shows the value of this combination in cell viability (see Example II) and in yeast budding detection (see Example III).

Cell viability is an important parameter to measure in flow cytometric analyses. It can be used as a quantitative parameter to assess the cytotoxicity of exogenous substrates or drugs, cytotoxic cellular interactions or as a method to eliminate dead cells from immunofluorescence analysis since non-viable cells may show different patterns of non-specific antibody binding compared to intact viable, competent cells. There are several methods that can be used to quantitate viability of cells. Some of these methods use a non-permeant dye such as propidium iodide that does not enter cells with intact cell membranes or active cell metabolism. Cells with damaged plasma membranes or with impaired or no cell metabolism are unable to prevent the dye from entering the cell. Once inside the cell, the dyes bind to intracellular structures, producing highly fluorescent adducts which identify the cells as “non-viable”.

An apparatus of the invention can be used to detect cells stained with an antibody, for example, an antibody labeled with a fluorescent label or bound to a secondary antibody that is fluorescently labeled. An apparatus of the invention can also be adapted for use as a fluorescent activated cell sorter (FACS). In such a case, a fluorescently labeled cell, for example, labeled with an antibody as discussed above, can be sorted. Various uses of a flow cytometer or FACS are well known to those skilled in the art, including but not limited to those disclosed herein. An apparatus of the invention can further be used, for example, to analyze bacteria, viruses, or micro particles. Thus, the invention provides methods for analyzing bacteria, viruses or micro particles using an apparatus of the invention.

It is understood that modifications which do not substantially affect the activity of the various embodiments of this invention are also provided within the definition of the invention provided herein. Accordingly, the following examples are intended to illustrate but not limit the present invention.

### EXAMPLE I

### Viability Assays

This example describes exemplary protocols and assays for measuring cell viability.

Protocol for viability using propidium iodide (PI). (1) Harvest cells and prepare single cell suspension in buffer, for example, phosphate buffered saline (PBS)+2% fetal bovine serum (FBS) or PBS+0.1% bovine serum albumin (BSA). (2) Wash cells 2 times and resuspend at 1−2×10⁶ cells/ml. (3) Stain with monoclonal antibodies as required. (4) Resuspend in 1 ml staining buffer and assess autofluorescence signals for unstained cells. Establish photomultipler tube (PMT) voltage settings for each fluorescence channel and set compensations for FITC and PE positive controls, if needed. (5) Add 10 ml of PI staining solution to a separate tube of unstained cells, mix gently and incubate 1 min. Propidium iodide staining solution is genearily 10 mg/ml PI (available from Sigma, St. Louis Mo.) in PBS. (6) Determine PI fluorescence (FL2 or FL3 on the FACScan) and compensate signals accordingly. (Use FL2 if staining only with PI. If using FITC- and PE-labeled antibodies, collect PI fluorescence in FL3). (7) Acquire data for unstained cells, single-color positive controls. Add PI to each subsequent sample prior to analysis and set the stop count on the viable cells from a dot-plot of FSC vs PI.

Protocol for viability using 7-AAD. (1) Harvest cells and prepare single cell suspension in buffer, for example, PBS+2% FBS or PBS+0.1% BSA. (2) Wash cells 2 times and resuspend at 1−2×10⁶ cells/ml. (3) Stain with monoclonal antibodies as required. (4) Resuspend in 1 ml staining buffer and assess autofluorescence signals for unstained cells. (5) Establish PMT voltage settings for each fluorescence channel and set compensations for FITC and PE positive controls if needed. (6) Add 10 ml of 7-AAD staining solution to a separate tube of unstained cells, mix gently and incubate 30 min. at 4° C. in the dark. 7-AAD staining solution is generally 1 mg/ml 7-AAD (available from Sigma) in PBS. Prepare stock 7-AAD 10 mg/ml in dimethyelsulfoxide (DMSO) and dilute 1:100 in PBS (7) Determine 7-AAD fluorescence (FL3 on the FACScan) and compensate signals accordingly. (8) Acquire data for unstained cells, single-color positive controls. Add 7-AAD to each subsequent sample prior to analysis and set the stop count on the viable cells from a dot-plot of FSC vs 7-AAD.

Protocol for FDA and PI viability. (1) Harvest cells and prepare single cell suspension in buffer, for example, PBS+2% FBS or PBS+0.1% BSA. (2) Wash cells 2 times and resuspend at 1−2×10⁶ cells/ml. (3) Add 10 ml of FDA working solution and 30 ml of PI working solution. Propidium iodide stock solution is 100 mg/ml PI in PBS. Dilute 100 ml stock solution in 1 ml PBS for the working solution. Fluorescein diacetate stock solution is 5 mg/ml FDA (available from Sigma) in ethanol. Dilute 40 ml stock solution in 10 ml PBS for working solution. (4) Incubate at room temperature for 3 min and place on ice until analyzed. (5) Prepare single color controls for compensation. Cells fixed in 1% paraformaldehyde can serve as a non-viable, positive control.

### EXAMPLE II

### Detection of Cell Viability

This example describes a cell viability assay using Jurkat cells.

Jurkat cells were prepared both stained and unstained. The stained cells were prepared with the propidium iodide (PI ) method (see Example I). The cells were then gated for live cells (red) and dead cells (green). The Volume vs. Side scatter display was back gated to show which of the two populations were viable.

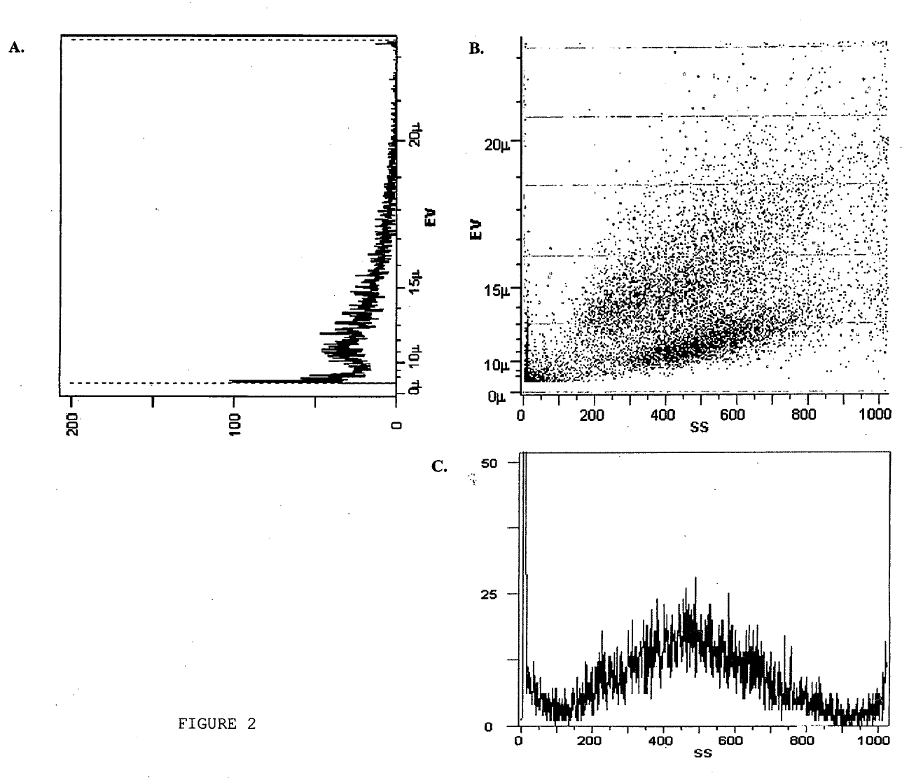

FIGS. 2A-2C show three graphs of the unstained Jurkat cells. FIG. 2A shows the Electronic Cell Volume distributions of the cells. FIG. 2C shows the Side Scatter (light) distribution of the same cells. FIG. 2B shows a cell-by-cell representation of the Electronic Cell Volume and Side Scatter data for each individual cell in the population.

It is clear that, without staining the sample, the Side Scatter vs. Electronic Volume graph gives a very good representation of Cell Viability. Thus, a very simple low cost instrument can be used to do this detection with the Electro-Optical Flow Cell disclosed herein.

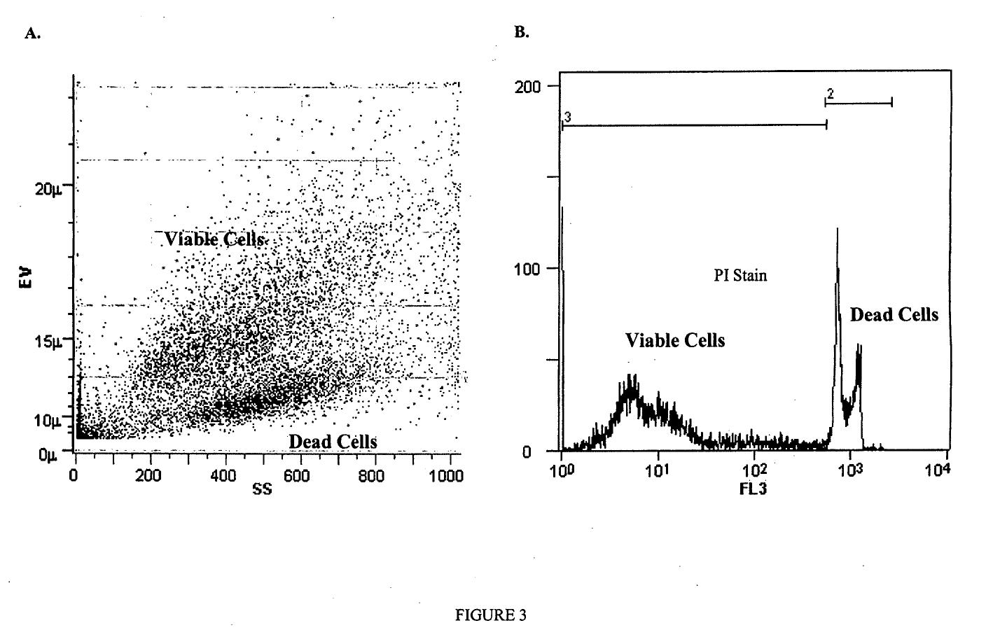

FIGS. 3A and 3B shows cell viability of Jurkat cells stained with propidium iodide for cell viability analysis and back gated into the Electronic Cell Volume (ECV) versus Side Scatter (SS). It is clear that the dead cells are clearly differentiated from the viable cells.

### EXAMPLE III

### Detection of Yeast Budding

Detection of the early budding process in yeast cells has been a very difficult task to accomplish. Various combinations of DNA stains and light scatter have been used to attempt to detect this process. The reliable DNA staining has been difficult because of the impermeable nature of the yeast cells.

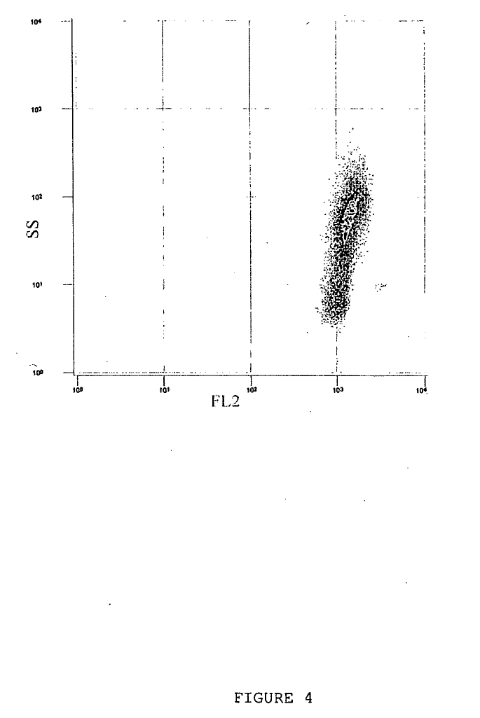

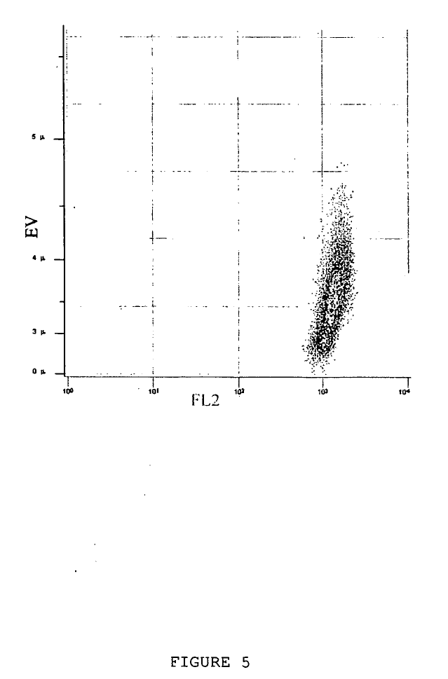

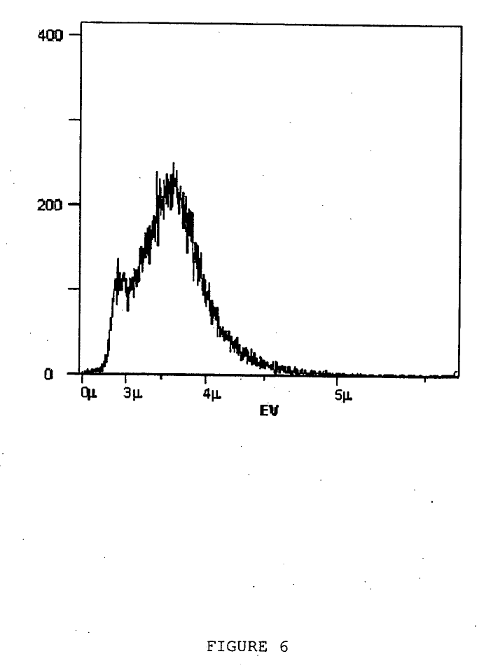

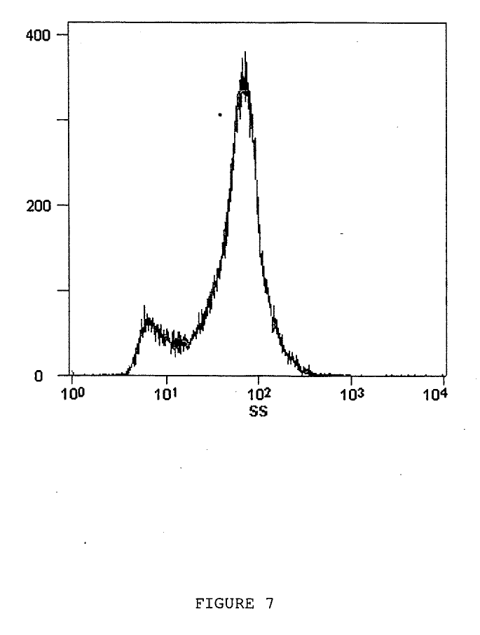

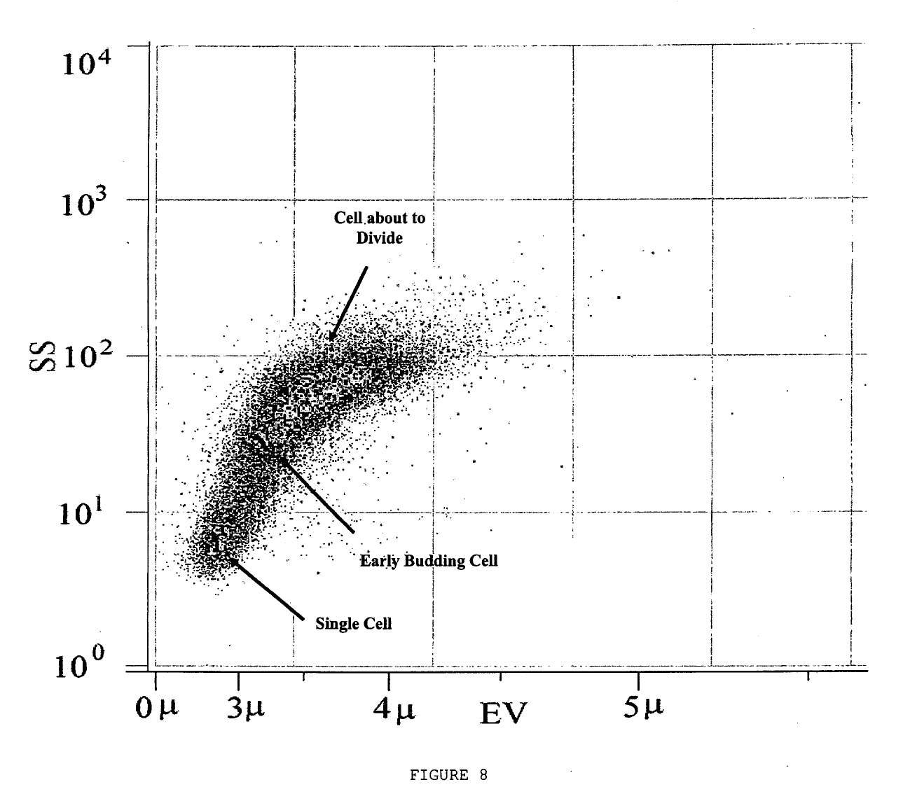

The data show in FIG. 4 shows a typical Side Scatter vs DNA plot, where the cells have been stained with PI after permeabilization. FIG. 5 is a plot of the same cells using Electronic Cell Volume vs DNA. FIG. 6 is a plot of the Electronic Volume distribution of the same cells. FIG. 7 is a plot of the Side Scatter distribution of the same cells. FIG. 8 shows yeast budding detection by combining electronic cell volume with light scatter. Depicted is a plot of Electronic Cell Volume vs Side Scatter on the same cells.

Side scatter in combination with DNA fluorescence (FIG. 4) shows some hint of the early budding cells, just below the main population of cells, whereas Electronic Cell Volume in combination with DNA (FIG. 5) does not. Neither parameter alone shows any information on early budding.

The combination of Side Scatter with Electronic Cell Volume (FIG. 8) produces a clear population of early budding cells with out any staining of the cells.

Throughout this application various publications have been referenced. The disclosures of these publications in their entireties are hereby incorporated by reference in this application in order to more fully describe the state of the art to which this invention pertains. Although the invention has been described with reference to the examples provided above, it should be understood that various modifications can be made without departing from the spirit of the invention.

What is claimed is:

1. A flow transducer comprising means defining an aperture having an axis, said aperture having at least one flat side, means defining an inlet chamber and an outlet chamber immediately adjacent the aperture along its axis, at least one of said inlet and outlet chamber having walls disposed at an angle of at least 5 degrees relative to a plane of the aperture, said at least one of said inlet and outlet chambers at a distance from the aperture of twice the width of the aperture in a plane through its axis having a cross-section area greater than 1.10 but less than 10 times the cross-sectional area of said aperture.

2. The flow transducer in accordance with claim 1 wherein said transducer is formed of a plurality of solid polygons joined such that adjacent flat surfaces of said polygons define walls of the aperture for the flow transducer, and others of the surfaces of said polygons define said at least one of said inlet and outlet chambers.

3. The flow transducer in accordance with claim 2, wherein others of the interior surfaces of said polygons define said at least one of said inlet and outlet chambers, and others of the exterior surfaces of said polygons form optical elements that are flat, spherical, aspherical or have a graded index to focus the exciting light, the emitted light, or the scattered light.

4. A flow cytometer for making simultaneous electronic and optical measurements on a particle flowing through a sensing zone thereof, comprising a transducer formed of a plurality of solid polygons joined such that adjacent flat surfaces of said polygons define a polygonal aperture at the sensing zone and other surfaces of said polygons define inlet and outlet chambers to said aperture, at least one of said inlet and outlet chambers having a predefined geometric relation to said aperture, said inlet and outlet chambers defining an arch shaped fluid passageway with the aperture at the arch vertex, means for establishing a flow of electrolyte through said aperture, said inlet and outlet chambers being configured to establish laminar flow of said electrolyte through said aperture, injector means for injecting samples of particles into said laminar flow of electrolyte, one or more electrodes coupled to said inlet chamber and one or more electrodes coupled to said outlet chamber, means for establishing a current flow through said aperture between said electrodes, monitoring means for monitoring the electrical current flow through said aperture, at least one of the solid polygons defining said aperture being an element in an optical measurement system, said system including means for introducing exciting light through said at least one solid polygon into said aperture, and means for collecting light from a sample particle in said aperture through the same polygon or another polygon.

5. The flow cytometer of claim 4, wherein at least one of said inlet and outlet chambers at a distance from the aperture of twice the width of the aperture in a plane through its axis having a cross-section area greater than 1.10 but less than 10 times the cross-sectional area of said aperture.

6. A flow transducer comprising means defining an aperture having an axis, said aperture having at least one flat side, means defining an inlet chamber and an outlet chamber immediately adjacent the aperture along its axis, at least one of said inlet and outlet chamber having some part of the wall curved walls, where said chambers at a distance from the aperture of twice the width of the aperture in a plane through its axis having a cross-section area greater than 1.5 times the cross-sectional area of said aperture, and said aperture length greater than 0.1 times the width of the aperture, and less than 4 times the width of the aperture, where the width is the largest dimensions measured perpendicular to the axis.

7. A transducer in accordance with claim 6 wherein said transducer is formed of a plurality of solid polygons joined such that adjacent flat surfaces of said polygons define walls of the aperture for the flow cytometer, and others of the surfaces of said polygons define said at least one of said inlet and outlet chambers.

8. The flow transducer in accordance with claim 7, wherein others of the interior surfaces of said polygons define said at least one of said inlet and outlet chambers, and others of the exterior surfaces of said polygons form optical elements that are flat, spherical, aspherical or have a graded index to focus the exciting light, the emitted light, or the scattered light.

9. A flow cytometer for making simultaneous electronic and optical measurements on a particle flowing through a sensing zone thereof, comprising a transducer such as a flow cell formed of a plurality of solid polygons joined such that adjacent flat surfaces of said polygons define a polygonal aperture at the sensing zone and other surfaces of said polygons define inlet and outlet chambers to said aperture, at least one of said inlet and outlet chambers having a predefined geometric relation to said aperture, said inlet and outlet chambers defining an arch shaped fluid passageway with the aperture at the arch vertex, means for establishing a flow of electrolyte through said aperture, said inlet and outlet chambers being configured to establish laminar flow of said electrolyte through said aperture, injector means for injecting samples of particles into said laminar flow of electrolyte, one or more electrodes coupled to said inlet chamber and one or more electrodes coupled to said outlet chamber, means for establishing a current flow through said aperture between said electrodes, monitoring means for monitoring the electrical current flow through said aperture, at least one of the solid polygons defining said aperture being an element in an optical measurement system, said system including means for introducing exciting light through said at least one solid polygon into said aperture, and means for collecting light from a sample particle in said aperture.

10. A flow cytometer comprising:
an aperture configured to provide a pathway for a stream of particles;
a lamp configured to epi-illuminate at least a portion of the pathway;
a laser configured to illuminate the pathway in a direction approximately orthogonal to illumination from the lamp; and
a detector system configured to detect a result on the stream of particles from both the lamp and the laser.

11. The flow cytometer of claim 10, wherein the detector system includes a single objective lens.

12. The flow cytometer of claim 10, wherein the detector system is configured to sense side scatter resulting from the laser.

13. The flow cytometer of claim 10, wherein the detector system includes a sensing window of approximately 120 degrees.

14. The flow cytometer of claim 10, wherein the aperture comprises a polygon having an equilateral triangular cross-section shape.

15. The flow cytometer of claim 14, wherein an attack angle of illumination from the laser is approximately +4.5 degrees relative to a base of the aperture.

16. The flow cytometer of claim 14, wherein illumination from the laser while in the aperture is approximately parallel to a base of the aperture.

17. The flow cytometer of claim 10, further comprising:
a fiber configured to direct illumination from the laser onto the pathway.

18. A method for identifying viable cells, comprising passing a population of cells through the flow transducer of claim 1 and identifying viable cells in said cell population.

19. A method for identifying budding yeast, comprising passing a population of yeast cells through the flow transducer of claim 1 and identifying budding yeast cells in said cell population.
